(19) United States
(12) Patent Application Publication
(10) Pub. No.: US 2007/0109540 A1
(43) Pub. Date: May 17, 2007

(54) Method for measuring thin films

(75) Inventor: Alexei Maznev, Natick, MA (US)

Correspondence Address: GOODWIN PROCTER LLP;PATENT ADMINISTRATOR, EXCHANGE PLACE, BOSTON, MA, 02109-2881, US

(73) Assignee: KONINKLIJKE PHILIPS ELECTRONICS N.V., Eindhoven (NL)

(21) Appl. No.: 10/553,146

(22) PCT Filed: Apr. 12, 2004
(86) PCT No.: PCT/IB04/01107

§ 371 Date: Oct. 25, 2006

Related U.S. Application Data
(60) Provisional application No. 60/463,259, filed on Apr. 16, 2003.
(60) Provisional application No. 60/489,629, filed on Jul. 24, 2003.

(51) Int. Cl. G01N 21/00; G01B 11/14

(52) U.S. Cl. 356/432; 356/625

(57) ABSTRACT

The present invention provides a new method of laser-based metrology of very thin solid films (22) based on the generation of the refractive index grating in the gas or liquid medium in contact with the film (22). In a primary embodiment, excited acoustic waves (25) in the gas or liquid medium modulate an intensity of the diffracted probe beam resulting in a low-frequency component of the signal compared to the frequencies of the acoustic modes excited in the solid sample. Amplitude of this low-frequency component is correlated with the amount of energy absorbed by the film (22), and, consequently, with the film thickness, which provides a method for film thickness measurement as well as for a detection of a metal film on a dielectric underlayer.

This application claims the benefit of U.S. Provisional Application Ser. No. 60/463,259, filed Apr. 16, 2003, the teachings of which are incorporated herein by reference.

The invention relates to the field of optical metrology to determine properties of a sample, e.g., a thin film structure.

Non-contact optical methods of measuring properties of thin metal films deposited on, for example, silicon substrates or dielectric layers are in great demand for industrial process monitoring and control. Parameters of most interest for process control applications include thickness measurements of the metal films. While thickness of metal films currently used in microelectronics typically ranges from 100-200 Å to a few microns, further advancement of the technology requires the use of even thinner films, 100 Å or less in thickness. One application requiring measurement of metal films thinner than 100 Å is fabrication of advanced diffusion barriers for copper interconnects. Another potential application is the detection of metal residue on top of a dielectric layer that may remain at the end of a polishing step in the copper interconnect process, compromising the electrical properties of the circuit.

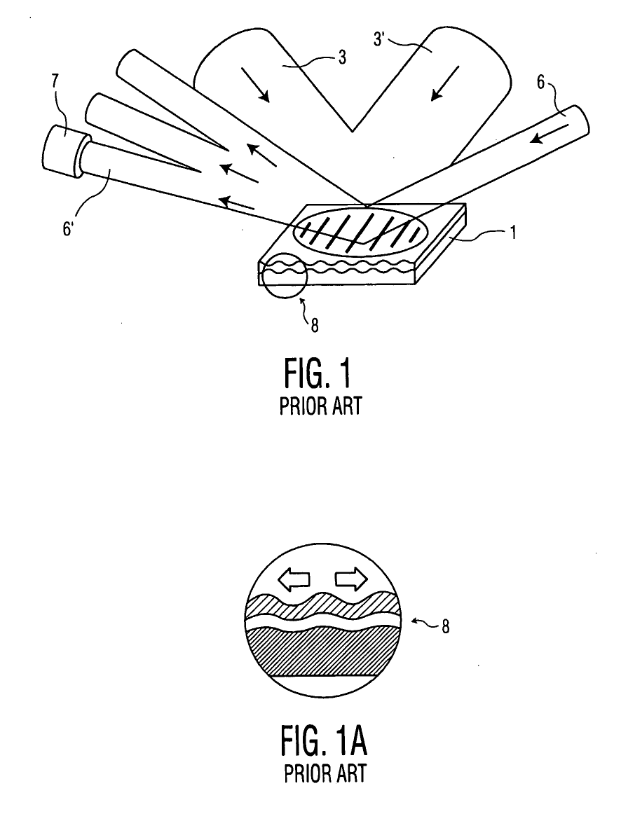

In one known method, as shown in FIG. 1, called laser-induced transient gratings or Impulse Stimulated Thermal Scattering (herein ISTS), a first excitation laser pulse 3, 3′ initiates a surface acoustic wave (SAW) that propagates in a plane of the film (see expansion 8). A second probe laser pulse 6, 6′ diffracts off the surface of the film 1 and sensors 7 measure the frequency of the SAW. The SAW frequency relates to film thickness. ISTS is described, for example, in U.S. Pat. No. 5,633,711 (entitled MEASUREMENT OF MATERIAL PROPERTIES WITH OPTICALLY INDUCED PHONONS) and U.S. Pat. No. 5,812,261 (entitled METHOD AND DEVICE FOR MEASURING THE THICKNESS OF OPAQUE AND TRANSPARENT FILMS) the contents of which are herein incorporated by reference.

The above-described technique has been successfully employed to measure the thickness of metal films in the range 100 Å10 □m. However, extending the measurement capabilities of the method to very thin films (<100 Å) has proved challenging. The principal difficulty lies in the fact that for a typical SAW wavelength of a few microns, a film thickness of a few tens on Angstroms would be on the order of 1/1000 of the SAW wavelength. Consequently, the film will have little effect on the SAW propagation thus making precise film thickness measurements based on the SAW frequency difficult.

A signal waveform generated using ISTS at a solid surface contains several components due to different physical processes initiated by the absorption of excitation light. Typically, the main contribution to the signal is due to diffraction of the probe beam off surface “ripples.” Surface displacement due to surface acoustic waves is responsible for a high-frequency component of the signal while the displacement associated with the temperature distribution gives rise to a slowly decaying component.

Another component of the signal is due to the variation of the refractive index of the air above the sample surface. Upon absorption of the excitation pulse at the sample surface, part of the generated heat is transferred to the air via thermal diffusion. This results in a spatially periodic temperature rise in the air. This impulsive air temperature rise also results in the excitation of acoustic waves. These acoustic waves cause periodic modulation in the refractive index of the probe pulse and contribute to its diffraction. Due to a relatively low speed of sound in the air, the frequency of the acoustic wave in the air is typically an order of magnitude lower than the SAW frequency at the same wavelength. Due to its low frequency, the contribution of the wave in the air can be easily distinguished from the other components of the signal.

The component of transient grating signal due to acoustic waves in the air has been noticed previously, for example in an article entitled OPTICAL MEASUREMENT OF THE ELASTIC MODULI AND THERMAL DIFFUSIVITY OF A C—N FILM by Yang et al. (J. Mater. Res., Vol. 10 No. 1, January 1995), but no attempts to extract useful information from this component of the signal have been made. It is therefore desirable to use this previously unused additional information contained in the ISTS signal.

In the present invention the component of transient grating signal caused by the disturbance of the refractive index of the gas or liquid medium in contact with the sample is used to detect and measure thickness of very thin metal films

In one aspect, the invention includes a method for measuring a film by exciting the film by irradiating it with a spatially periodic excitation field in order to generate a thermal grating; generating a spatially periodic refractive index disturbance in the gas or liquid medium in contact with the film via heat transfer from the film to the said medium;
diffracting a probe laser beam off the refractive index disturbances in the said medium to form a signal beam;
detecting the signal beam as a function of time to generate a signal waveform; and
determining at least one property of the film based the signal waveform.

In one embodiment of the invention, the film is a metal film. In another embodiment, the film is a metal film with a thickness less than 100 Å.

In another embodiment, the film is deposited over an underlaying layer, transparent to the excitation radiation. In still another embodiment the optical absorption coefficient of the underlaying layer at the excitation wavelength is smaller than the absorption coefficient of the film material.

In another embodiment, the gas medium in contact with the film is air.

In another embodiment the refractive index disturbance in the gas or liquid medium in contact with the sample is caused by the acoustic wave in the medium.

In another embodiment, the acoustic wave in the medium causes low frequency modulation of the signal waveform.

In another embodiment, the determining step is based on the analysis of the said low-frequency component of the signal waveform.

In another embodiment, the determining step comprises analysis of the signal waveform with an empirical calibration.

In still another embodiment, the determining step comprises analysis of the signal waveform with a theoretical model.

In another embodiment, the at least one property comprises the thickness of the film.

In still another embodiment, the at least one property comprises the presence of the film.

The invention provides many advantages that are evident from the following description, drawings, and claims.

The invention may be more completely understood in reference to the following figures:

FIG. 1 depicts a metal thin film probed using impulsive stimulated thermal scattering according to a prior art method;

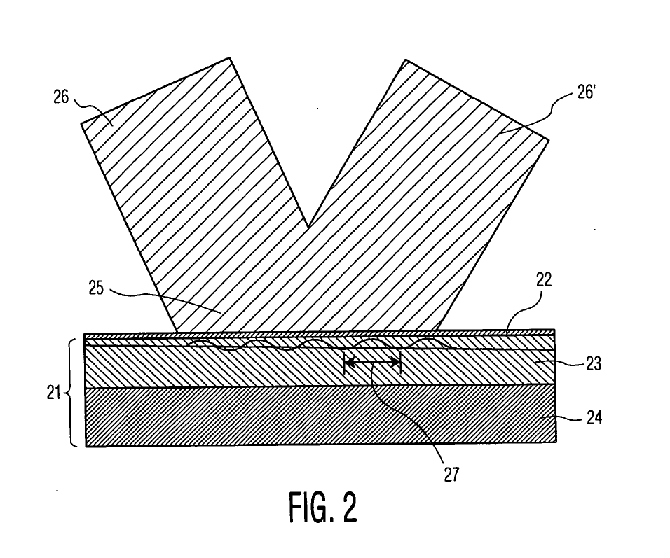

FIG. 2 depicts a metal thin film probed using impulsive thermal scattering according to the present invention;

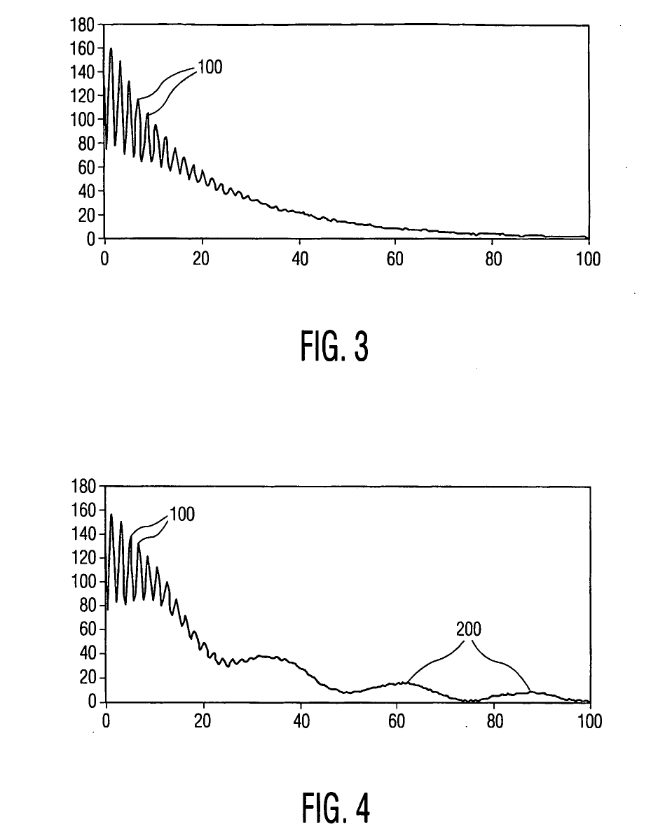

FIG. 3 depicts a signal waveform generated on a sample comprised of a SiO₂ layer on a Si wafer with no metal surface film;

FIG. 4 depicts a signal waveform generated on a sample comprised of a SiO₂ layer on a Si wafer with a very thin film of TiSiN deposited over the SiO₂ layer;

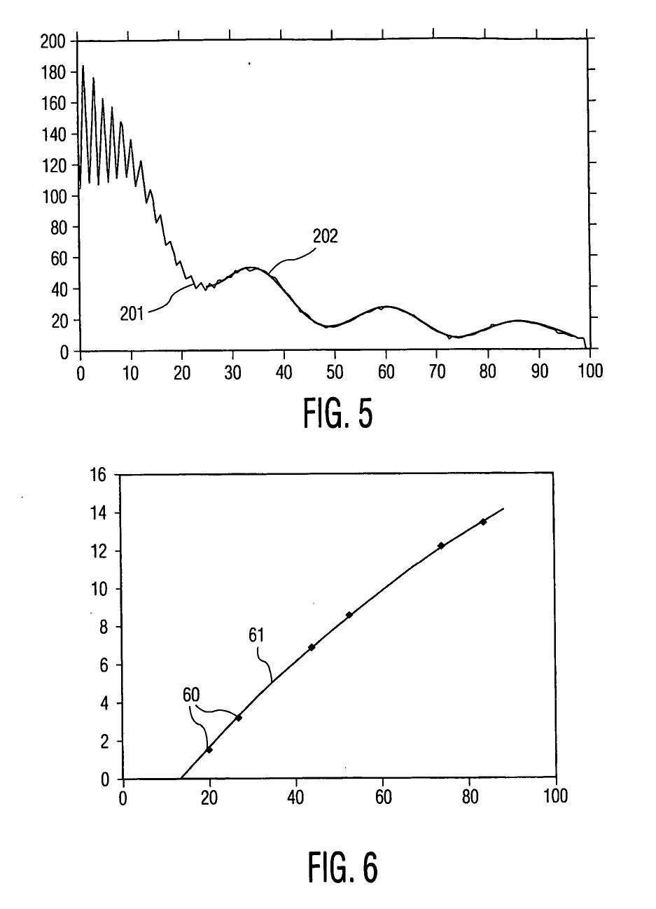

FIG. 5 depicts a signal waveform including a best fit according to equation 1;

FIG. 6 depicts a chart showing airwave amplitude versus metal film thickness;

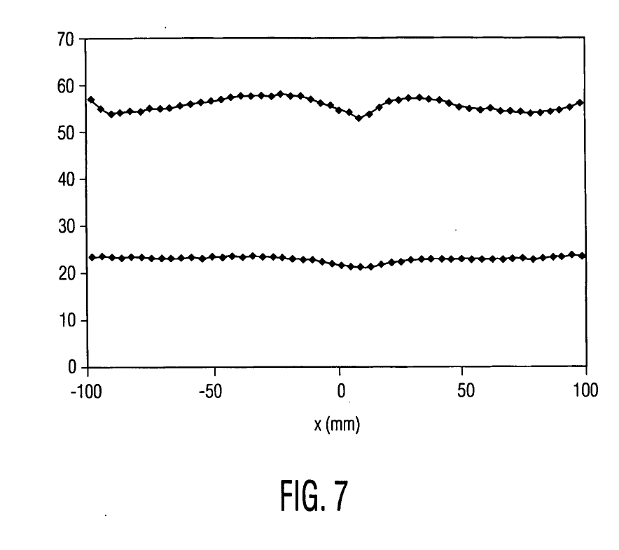

FIG. 7 depicts examples of diameter profiles of TiSiN film thickness measured according to the invented method.

In the newly invented method, the airwave signal is used to detect and measure thickness of a very thin metal film typically deposited over a dielectric layer on a silicon wafer.

FIG. 2 schematically shows a sample 21 with a very thin, semi-transparent metal film 22 deposited over a transparent dielectric 23 (e.g. SiO₂) layer on silicon substrate 24. Two short laser pulses 26, 26′ create a spatially periodic optical intensity pattern with period 27 similar to the prior art method. If the metal film 22 is absent, the absorption of the excitation light 26, 26′ takes place only in the Si substrate 24. No significant amount of heat is transferred to the air due to much lower thermal conductivity of typical interconnect dielectrics compared to silicon. Consequently, the acoustic wave in the air is not generated.

FIG. 3 shows the signal waveform measured on a sample comprised of a 0.55 □m-thick film of SiO₂ thermally grown on a silicon wafer, with the excitation period 8.86 □m. This waveform does not contain a contribution due to the acoustic wave generated in the air because metal film 22 is absent from the sample.

If a thin metal film 22 is present on the surface of the sample 21, a part of the excitation pulses' 26, 26′ energy will be absorbed in the film 22 and transferred to the air via thermal diffusion. FIG. 2 depicts this transfer as arrows 25. This results in the impulsive thermal expansion of the air and excitation of an acoustic wave, modulating the refractive index of the air. The resulting spatially periodic variation of the refractive index of the air will act upon the probe beam 6 as a diffraction grating thus contributing to the diffracted signal beam 6′.

FIG. 4 depicts a signal waveform measured under the same conditions as the waveform depicted in FIG. 3. on a sample, comprised of a 46 Å of chemical-vapor-deposited TiSiN film on 0.55 □m SiO₂ on a Si wafer. Thus the only difference between measurements shown in FIG. 3 and FIG. 4 is the presence of a very thin TiSiN film 22 in the latter case. One can see that the signal waveform is now modulated with slow oscillations 200. Dividing the acoustic wavelength of 8.86 □m determined by the spatial period of the excitation pattern by the period of the slow oscillations 200 25.4 ns results in a velocity of 349 m/s, i.e., the sound velocity in the air under typical conditions. Consequently, the slow oscillations 200 correspond to the component of the signal due to the acoustic wave in the air caused by the heat transfer from the TiSiN film 22 to the air above the film. Due to its low frequency, the contribution of the acoustic wave in the air to the signal can easily be distinguished from the other components of the signal (e.g. SAW component, responsible for the high frequency oscillations 100 in the waveform).

Since the signal component due to the acoustic wave in the air vanishes when the metal film thickness is zero, the amplitude of this signal component must increase with the film thickness within a certain thickness range. The thicker the film, the more excitation energy it absorbs, and the more energy is eventually transferred into the air. This trend can be observed as long as the film is mostly transparent i.e. up to ˜100-300 Å, depending on material. For thicker, opaque films, the trend becomes reversed. This is because for a thicker film, the heat transfer across the film thickness will cool down the surface of the film, thus decreasing the amount of heat transferred to the air.

Thus for films <100 Å in thickness, there exists a correlation between the amplitude of the slow oscillations 200 in the signal and the film thickness. This allows the use of the amplitude of the slow oscillations 200 for film thickness measurements.

In order to find the said amplitude, the “tail” of the signal waveform is fitted to the following functional form comprised of the sum of an exponentially decaying function, decaying oscillations and a constant offset:
S=Aexp(−t/□₁)+Bexp(−t/□₂)sin(□t+□)+C (1)
The frequency □, phase □ and decay time □₂ of the airwave were determined based on the data from one of the TiSiN film samples and then fixed at the determined values. Other parameters i.e. A, □₁B and C were varied in a multi-parameter fit, with the best fit value of B taken as the airwave amplitude. FIG. 5 illustrates the fitting procedure, with the line 201 showing the measured signal waveform and the line 202, juxtaposed with a portion of line 201, showing the best fit calculated according to equation (1).

FIG. 6 depicts the measured amplitude of the slow oscillating component of the signal for a set of TiSiN film samples that was also measured by another known method of grazing-incidence x-ray reflectivity (XRR). The symbols 60 in FIG. 6 represent experimentally measured data while the line 61 connecting the symbols 60 represents the interpolated polynomial curve that was used as a calibration curve in the subsequent measurements. The correlation between the measurements done with the invented method and XRR is quite good. The fact that the interpolated curve intercepts the x-axis not at zero but rather at a point corresponding to about 13 Å indicates that the films were partially oxidized due to an exposure to an ambient air during the time between the film deposition and the measurement. Metal oxides typically have much smaller absorption coefficient compared to metals; consequently, the invented method is only sensitive to the remaining non-oxidized part of the metal film 22.

FIG. 7 depicts diameter profiles of two TiSiN films deposited on Si wafers 200 mm in diameter with 0.55 □m thermally grown SiO₂. Measuring the amplitude of the slow oscillations 200 in the signal according to the procedure described above and applying an empirical calibration according to FIG. 6 obtained the data. To improve signal-to-noise, the data were averaged over 10 consecutively measured diameter scans. It should be noted that while an above measurement example utilized an empirical calibration, the method can be enhanced by using a theoretical model including the following steps:

(1) Calculation of optical absorption in the measured film deposited over a multi-layer structure. This can be done according to the methods known in the art;

(2) Solving the thermal diffusion problem to determine the temperature increase in the gas or liquid medium in contact with the sample; and

(3) Calculating the amplitude of the acoustic wave generated in the gas or liquid medium.

The models and methods that can be employed for solving thermal diffusion and acoustical problems (2) and (3) for a liquid in contact with a solid sample are known in the art.

The data shown in FIG. 7 represent an example of a practical application of the invented method to the measurement of the thickness and uniformity of chemical-vapor-deposited barrier films for Cu interconnects (thickness ˜50 Å).

Note, that metal films of 100 Å and thinner can be measured by other techniques such as XRR technique mentioned above, as well as spectroscopic ellipsometry. An advantage of the method of the invention is in its high selectivity, i.e., in that the component of transient grating signal due to acoustic waves in the air results entirely from the presence of the metal film. This is particularly advantageous in applications where one needs to detect the presence of a metal film, e.g., metal residue detection after chemical-mechanical polishing (CMP) of copper interconnect structures. Another advantage is that the measurement can be performed with a standard commercially available ISTS instrument, which allows for measurements of very thin films according to the present invention, as well as measurements of thicker films with a prior art ISTS technique with a single instrument.

It should be noted that the described mechanism of the acoustic wave excitation in the air will be equally valid for a different gas or liquid medium in contact with the sample. Measurement of samples immersed in a liquid can have potential applications such as in-situ control of the CMP process. The invention provides many additional advantages that are evident from the description, drawings, and claims.

The preceding expressions and examples are exemplary and are not intended to limit the scope of the claims that follow.

1. A method for measuring a film (22) comprising:
irradiating the film (22) with a spatially periodic optical excitation field (3, 3′) in order to generate a thermal grating;
generating a spatially periodic refractive index disturbance in a gas or liquid medium contacting the film (22) via heat transfer (25) from the film (22) to said medium;
diffracting a probe laser beam (6) off the refractive index disturbances in the said medium to form a signal beam (6′);
detecting the signal beam (6′) as a function of time to generate a signal waveform; and
determining at least one property of the film (22) based on the signal waveform.

2. The method of claim 1, wherein the film (22) comprises a metal film.

3. The method of claim 2, wherein the film (22) is a metal film with a thickness less than 100 angstroms.

4. The method of claim 1, wherein the film (22) is deposited on an underlayer that is transparent to the excitation radiation.

5. The method of claim 4, wherein the film (22) is deposited on the underlayer characterized by a smaller absorption coefficient at the excitation wavelength compared to the film material.

6. The method of claim 1, wherein the medium in contact with the film is air.

7. The method of claim 1, wherein the refractive index disturbance in the medium is associated with the acoustic wave.

8. The method of claim 7, wherein the acoustic wave in the medium causes low frequency modulation (200) of the signal waveform.

9. The method of claim 9 wherein the determining step is based on the analysis of the said low-frequency modulation (200) of the signal waveform.

10. The method of claim 1, wherein the determining step comprises analysis of the signal waveform with an empirical calibration.

11. The method of claim 1, wherein the determining step comprises analysis of the signal waveform with a theoretical model comprising calculation of optical absorption by the film (22);
analysis of thermal diffusion (25) causing temperature increase in the gas or liquid medium in contact with the film (22);
analysis of the acoustic wave excitation caused by the temperature increase;
analysis of the probe beam (6′) diffraction off the refractive index disturbance caused by the temperature increase (25) and acoustic waves (27) in the medium.

12. The method of claim 1, wherein the at least one property comprises a thickness of the film (22).

13. The method of claim 1, wherein the at least one property comprises a presence of the film (22).
